(19) United States
(12) Patent Application Publication
(10) Pub. No.: US 2007/0258591 A1
(43) Pub. Date: Nov. 8, 2007

(54) CIPHERING CONTROL AND SYNCHRONIZATION IN A WIRELESS COMMUNICATION SYSTEM

(75) Inventors: Stephen E. Terry, Northport, NY (US); Peter S. Wang, E. Setauket, NY (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/743,889

(22) Filed: May 3, 2007

Related U.S. Application Data
(60) Provisional application No. 60/798,118, filed on May 5, 2006.
(60) Provisional application No. 60/815,247, filed on Jun. 19, 2006.

(51) Int. Cl. H04K 1/00

(52) U.S. Cl. 380/247

(57) ABSTRACT

Ciphering control and synchronization for both U-plane data and C-plane signaling messages in a wireless communication network are disclosed. Ciphering entities are located in a wireless transmit/receive unit (WTRU) and a network. The ciphering entities of the WTRU and the network perform ciphering control and ciphering parameter synchronization. The ciphering may be performed with a packet data convergence protocol (PDCP) layer sequence number (SN) for user plane data, a non-access stratum SN, a radio resource control SN, or an encryption SN for a control plane message. Alternatively, the ciphering control and ciphering parameter synchronization may be performed by PDCP entities of the WTRU and the network. For ciphering parameter synchronization, HFN and SN synchronization and counter check procedures are performed by the WTRU and the network based on a synchronization command message, sequence number window information, or a counter check message exchanged between the WTRU and the network.

### CROSS REFERENCE TO RELATED APPLICATIONS

This application claims the benefit of U.S. Provisional Application Nos. 60/798,118 filed May 5, 2006 and 60/815,247 filed Jun. 19, 2006, which are incorporated by reference as if fully set forth.

### FIELD OF INVENTION

The present invention is related to securing wireless communications. More particularly, the present invention is related to ciphering control and synchronization for user plane (U-plane) data and control plane (C-plane) signaling messages in a wireless communication system including a third generation (3G) long term evolution (LTE) network.

### BACKGROUND

FIG. 1 shows conventional security and automatic repeat request (ARQ) operations in a conventional universal terrestrial radio access network (UTRAN) 100. In the conventional UTRAN 100, ciphering entities 112 and 132 are located in a user equipment (UE) 110 and a radio network controller (RNC) 130 along with a radio link control (RLC) entity 114, 134, (i.e., outer ARQ entity) and a radio resource control (RRC) entity 116, 136. Both the ciphering entity 112, 132 and the RLC entity 114, 134 use RLC protocol data unit (PDU) sequence numbers (SNs) as an input parameter for the data block encryption and ARQ operations, respectively. By way of background, ciphering is performed to provide authentication and radio link privacy to users on a network by scrambling the user's voice and data traffic.

In the conventional UTRAN 100, the ciphering and integrity protection algorithms, (e.g., f8 and f9 algorithms), are driven by counters, (Count-C and Count-I). There is one Count-C per uplink radio bearer and one Count-C per downlink radio bearer. There is also one Count-I in each direction per signaling radio bearer. The Count-C value and the Count-I value are inputs for the f8 and f9 ciphering and integrity check algorithms. The Count-C value and Count-I value include a hyper frame number (HFN) and an SN. The HFN value is the most significant bits (MSBs) of the Count-C and Count-I values and is incremented each SN cycle. The RLC entity 114, 134 controls ciphering parameters and the HFN synchronization.

The RRC entities 116, 136 perform a counter check mechanism for examining Count-C integrities between the UTRAN 100 and the UE 110 for radio bearers with acknowledged mode (AM) and unacknowledged mode (UM). When the counter check procedure is triggered, the RNC 130 sends a counter check message to the UE 110. The counter check message includes the most significant part of the Count-C values, (25 MSBs), for each active radio bearer. The UE 110 compares the Count-C MSBs with its local equivalents. If there is any discrepancy, the UE 110 reports it via a counter check response message to the RNC 130. The RNC 130 then may release the radio bearer having the discrepancy.

The third generation partnership project (3GPP) has recently initiated a long term evolution (LTE) of the third generation (3G) system to bring new technology, new network architecture and configuration, and new applications and services to the wireless cellular network in order to provide improved spectral efficiency, reduced latency, faster user experiences and richer applications and services with lower cost.

FIG. 2 shows security and ARQ operations proposed for the LTE system 200. In the proposal, the ciphering entity 132 previously located in the RNC 130 of FIG. 1 is moved to an access gateway (aGW) 230 while an RLC entity 222 and an RRC entity 224 are located in an evolved Node-B (eNode-B) 220. The ciphering entity 212, 232 may use a packet data convergence protocol (PDCP) SN (PDCP SN), (or alternatively a non-access stratum (NAS) SN (NAS SN)), and an HFN for ciphering.

FIG. 3 shows security and ARQ operations in another proposal for the LTE 300. In this proposal, in the control plane (C-plane), the PDCP layer 312, 332 is responsible for integrity protection and ciphering of the NAS control signaling messages, while in the user plane (U-plane) the PDCP layer is responsible for Internet protocol (IP) header compression and ciphering. However, the ciphering control and synchronization is not addressed in this proposal.

Given the proposed LTE architecture in FIGS. 2 and 3, the conventional RLC and its ciphering synchronization mechanism (RLC RESET) are not adequate in the LTE system, since the RLC entity is no longer responsible for performing the ciphering and deciphering.

Currently in a universal mobile telecommunication system (UMTS), due to high speed capability and demand, downlink packet reception experiences a burst of large number of incoming packets. For example, with a small SN length, (7 bits), for the conventional unacknowledged mode (UM) operation or in situations of data loss due to poor channel conditions or imperfect handover handling, repetition of SNs may cause ambiguity for HFN derivation from the received SNs since the SN is too short. A wrong HFN derivation not only impacts successful data deciphering but also deteriorates subsequent recovery on ciphering errors, ending up with a reset to the radio bearer. Besides, there is no mechanism in UM operation for HFN re-synchronization and SNs synchronization.

Therefore, it would be desirable to provide a ciphering control and synchronization method for the LTE system to ensure that both the U-plane data ciphering and the C-plane NAS signaling message ciphering operate well in the LTE network.

SUMMARY

The present invention is related to ciphering control and synchronization for both U-plane data and C-plane signaling messages in a wireless communication system including a 3G LTE network. Ciphering entities are located in a wireless transmit/receive unit (WTRU) and an LTE network. The ciphering entities of the WTRU and the LTE network perform ciphering control and ciphering parameter synchronization. The ciphering may be performed with a PDCP SN for user plane data, a NAS or RRC SN, or an encryption SN for a control plane message. Alternatively, the ciphering control and ciphering parameter synchronization may be performed by PDCP entities of the WTRU and the LTE network. For ciphering parameter synchronization, HFN and SN synchronization and counter check procedures are performed by the WTRU and the LTE network based on a synchronization command message, SN window information, or a counter check message exchanged between the WTRU and the LTE network.

### BRIEF DESCRIPTION OF THE DRAWINGS

A more detailed understanding of the invention may be had from the following description, given by way of example and to be understood in conjunction with the accompanying drawings wherein:

FIG. 1 shows conventional security and ARQ operations in a conventional UTRAN;

FIGS. 2 and 3 show security and ARQ operations previously proposed for LTE systems;

FIG. 4 shows security operations in an LTE network in accordance with one embodiment of the present invention;

FIGS. 5A-5C show exemplary data packets and a control packet in accordance with the present invention;

FIG. 6 is a signaling diagram of a process for HFN synchronization in accordance with the present invention;

FIG. 7 is a signaling diagram of a process for SN synchronization in accordance with the present invention;

FIG. 8 is a signaling diagram of a process for HFN check in accordance with the present invention;

FIG. 9 shows security operations in an LTE network in accordance with another embodiment of the present invention;

FIG. 10 shows a PDCP control packet in accordance with the present invention; and

FIG. 11 shows packet reordering operations in a WTRU and an LTE network in accordance with the present invention.

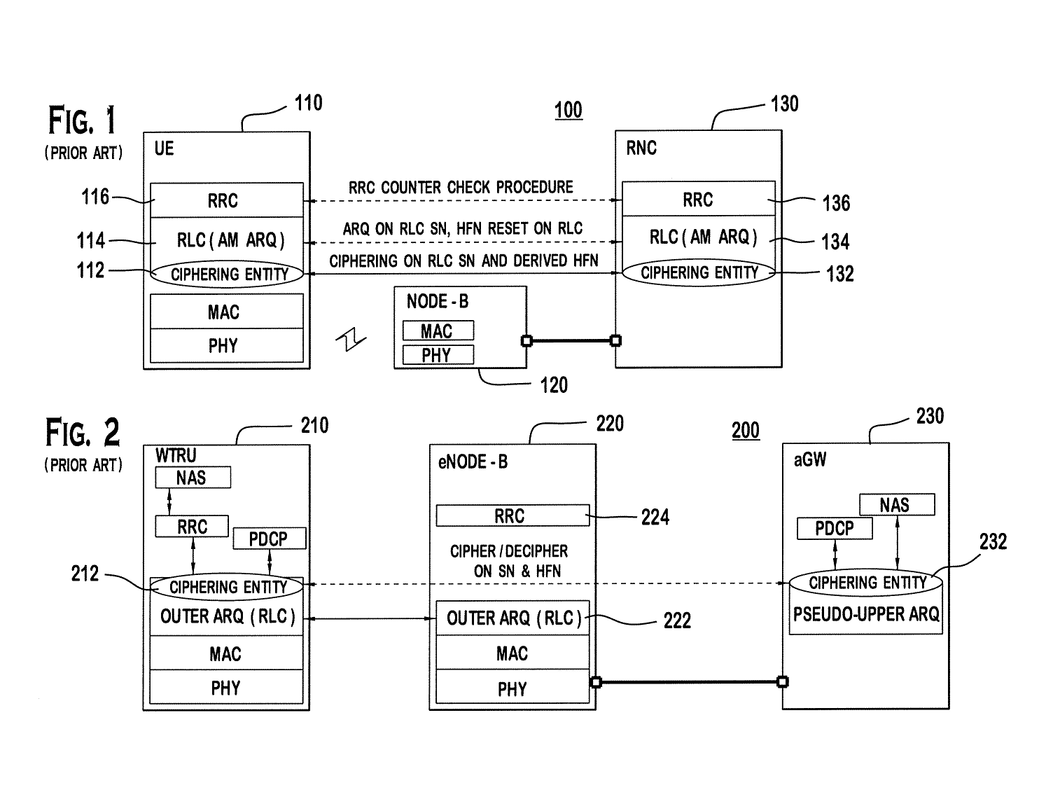

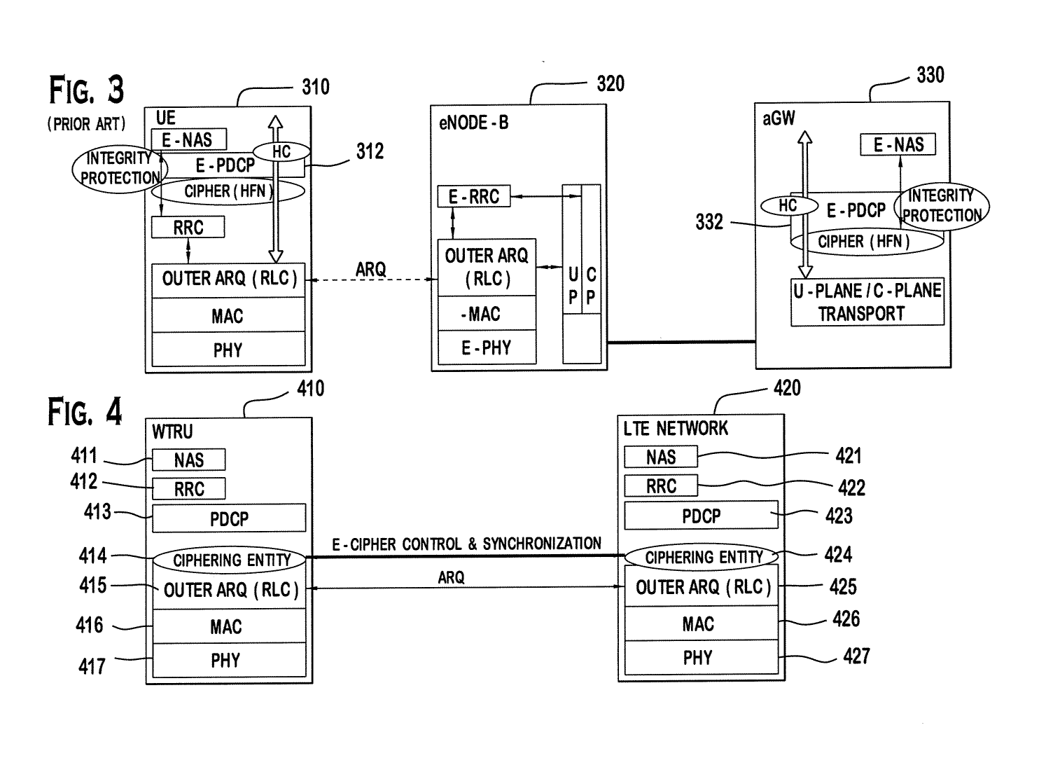

### DETAILED DESCRIPTION OF THE PREFERRED EMBODIMENTS

When referred to hereafter, the terminology “WTRU” includes but is not limited to a LE, a mobile station (STA), a fixed or mobile subscriber unit, a pager, a cellular telephone, a personal digital assistant (PDA), a computer, or any other type of user device capable of operating in a wireless environment.

FIG. 4 shows security operations between a WTRU 410 and an LTE network 420 in accordance with one embodiment of the present invention. The WTRU 410 includes an NAS entity 411, an RRC entity 412, a PDCP entity 413, a ciphering entity 414, an RLC entity 415, a medium access control (MAC) entity 416 and a physical layer (PHY) entity 417. The ciphering entity 414 communicates with the PDCP entity 413 for U-plane data and communicates with the RRC entity 412 and the NAS entity 411 for C-plane signaling messages directly or via the PDCP entity 413. The ciphering entity 414 performs ciphering for both the U-plane data and the C-plane signaling message. The ciphered data or message is transmitted via the RLC entity 415, the MAC entity 416 and the PHY entity 417.

The LTE network 420 includes an NAS entity 421, an RRC entity 422, a PDCP entity 423, a ciphering entity 424, an RLC entity 425, a MAC entity 426 and a PHY entity 427. The RLC entity 425 performs ARQ operation with the RLC entity 415. The ciphering entity 424 communicates with the PDCP entity 423 for U-plane data and for C-plane signaling messages with the RRC entity 422. The ciphering entity 424 performs ciphering for both the U-plane data and the C-plane signaling messages.

In accordance with one embodiment of the present invention, in addition to performing ciphering in the U-plane data and the C-plane messages, the ciphering entities 414, 424 perform ciphering control and ciphering parameter synchronization. An in-band control signaling may help managing the ciphering on the U-plane data and the C-plane signaling messages, benefiting both the RLC acknowledged mode (AM) and unacknowledged mode (UM) operations. In a conventional UMTS, RLC AM has limited synchronization through RLC RESET primitive while none for RLC UM. In accordance with the present invention, using PDCP primitive may provide ciphering synchronization to radio bearers running in both RLC AM and RLC UM.

On the U-plane, the ciphering entity 414, 424 uses a PDCP SN for ciphering. The PDCP entity 413, 423 always has a PDCP SN. The PDCP SN is used to encrypt and decrypt the PDCP payload and to derive encryption parameters, such as an HFN. The PDCP SN, (14 bits), is long enough to prevent the SN wrap-around from happening too soon, which results in HFN derivation ambiguity.

On the C-plane, the ciphering entity 414, 424 may use either an SN coming from the NAS entity 411, 421, from the RRC entity 412, 422 or from the PDCP entity 413, 423 or its own encryption SN. Given that the NAS control signaling is a relatively low volume compared to the U-plane data, the NAS SN or the encryption SN does not have to be long. For example, the NAS SN or the encryption SN may be a 6-bit SN.

For all packets processed through the ciphering entities 414, 424, a header is attached to the packets. The header includes a one bit control/data (C/D) field to indicate that the packet is a control packet or a data packet. The header may also include an SN length field, (i.e., a short/long (S/L) field), to indicate the length of the SN. With the SN length field, a plurality of different length SNs, (e.g., 6-bit SN or 14-bit SN), may be used for U-plane and/or C-plane.

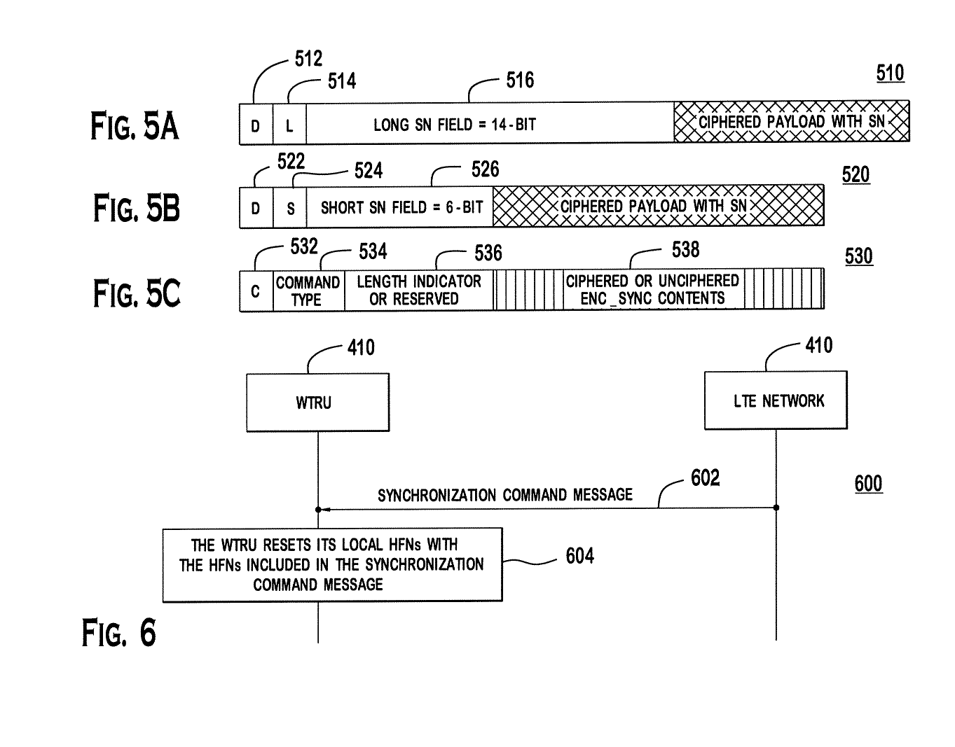

FIG. 5A shows an exemplary data packet 510 in accordance with the present invention. The C/D field 512 is set to ‘D’ to indicate the packet 510 is a data packet. The optional SN length field 514 is set to ‘L’ to indicate the SN 516 is a long SN, (e.g., a 14-bit SN). FIG. 5B shows another exemplary data packet 520 in accordance with the present invention. The C/D field 522 is set to ‘D’ to indicate the packet 520 is a data packet. The optional SN length field 524 is set to ‘S’ to indicate the SN 526 is a short SN, (e.g., a 6-bit SN).

FIG. 5C shows an exemplary control packet 530 in accordance with the present invention. The C/D field 532 is set to ‘C’ to indicate the packet 530 is a PDCP control packet. The control packet 530 also includes a command type field 534, (2 or 3 bits), and a length indicator field 536, (4 or 5 bits). The command type field 534 indicates the type of control message. The length indicator field 536 may be a reserved field. The payload 538 of the control packet 530 may or may not be encrypted. If the payload is encrypted, it may be encrypted, not by the SN, but by some other pre-agreed value between the network and the WTRU. For example, the pre-agreed value may be a WTRU identity, such as a radio network temporary identifier (RNTI), a packet temporary mobile subscriber identity (P-TMSI), or an international mobile subscriber identity (IMSI).

Since both the SNs for the PDCP entity and the RLC entity are on a radio bearer basis, inter-layer protocol handling entities are responsible for recognizing the correct radio bearer-identification associated with the packet and the length of the packet when the packet arrives. Therefore, the radio bearer ID and the length are not included in the header.

FIG. 6 is a signaling diagram of a process 600 for HFN synchronization, (i.e., Count-C synchronization), in accordance with the present invention. Since the HFN is a part of the Count-C value, the present invention will be described only with reference to HFN throughout the present invention. However, it should be noted that the present invention may be extended to synchronization and controlling of any ciphering parameters. For HFN synchronization between the WTRU 410 and the LTE network 420, the LTE network 420 sends a synchronization command message to the WTRU 410 (step 602). The synchronization command message is a control message including HFN synchronization related information for each radio bearer. The HFN synchronization related information includes a radio bearer ID, an uplink HFN to be used, a new uplink HFN activation time, (i.e., an SN), a downlink HFN to be used, and a new downlink activation time, (i.e., an SN). The transmission of the synchronization command message is triggered either by the network, (e.g., the RRC decision for handover or cell change), or by an error report from lower layers.

After receiving the synchronization command message, the WTRU 410 resets its local HFNs with the HFNs included in the synchronization command message (step 604). Since the ciphering entity 414 is located above the RLC entity 415, the synchronization command message may take care of all RLC AM, UM and transparent mode (TM) operations in terms of ciphering.

Alternatively, the WTRU 410 may initiate the HFN synchronization procedure 600 by sending a synchronization message including its local HFNs to the LTE network 420 if HFN out-of-sync is detected or whenever it is necessary. The LTE network 420 may then send a synchronization command message in response to the synchronization message from the WTRU to synchronize the HFNs.

As stated above, a payload of the control packet may or may not be encrypted. If the synchronization command message or the synchronization message as a payload is not encrypted, the HFN values in the synchronization command message or the synchronization message should be encoded. For example, the HFN values may be sent as a hash value of an agreed hash function.

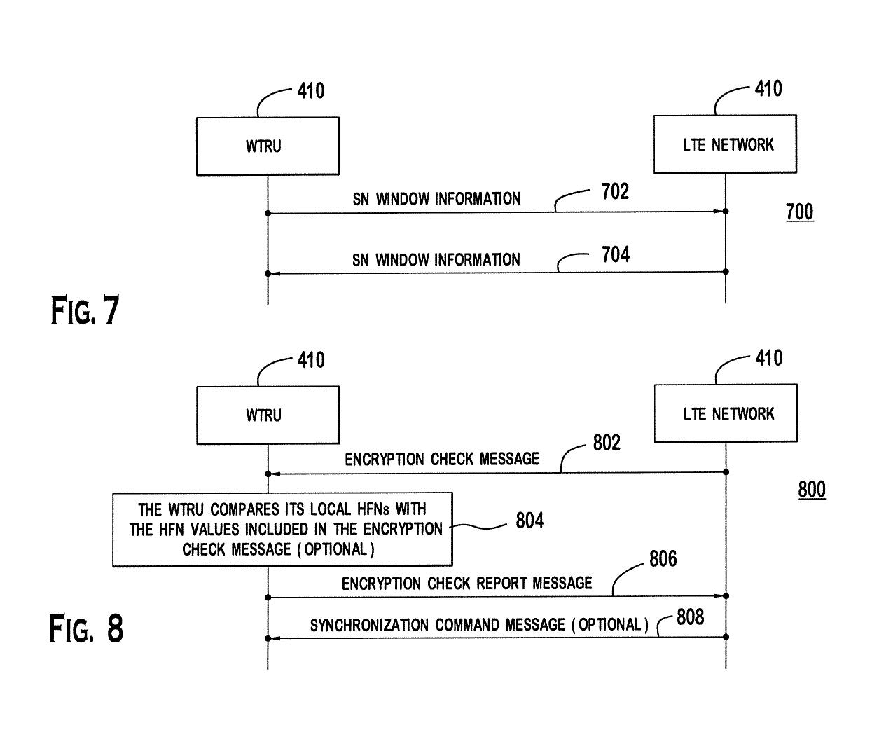

FIG. 7 is a signaling diagram of a process 700 for SN synchronization in accordance with the present invention. For SN synchronization, the WTRU 410 and the LTE network 420 send an SN window information per radio bearer to each other. The WTRU 410 sends the SN window information for synchronization in the uplink (step 702). The LTE network 420 sends the SN window information for synchronization in the downlink (step 704). Steps 702 and 704 do not have to occur in any specific order. The SN window information includes a start SN and a window size. Knowing the SN range helps eliminate the SN overrun and ambiguity and helps the receiver correctly derive the HFNs based on the received SNs. The SN window information may be sent when a transmitting entity is about to send a packet with an SN beyond the current SN window, when a handover or cell change occurs, or when the channel condition is poor and a packet error rate rapidly increases.

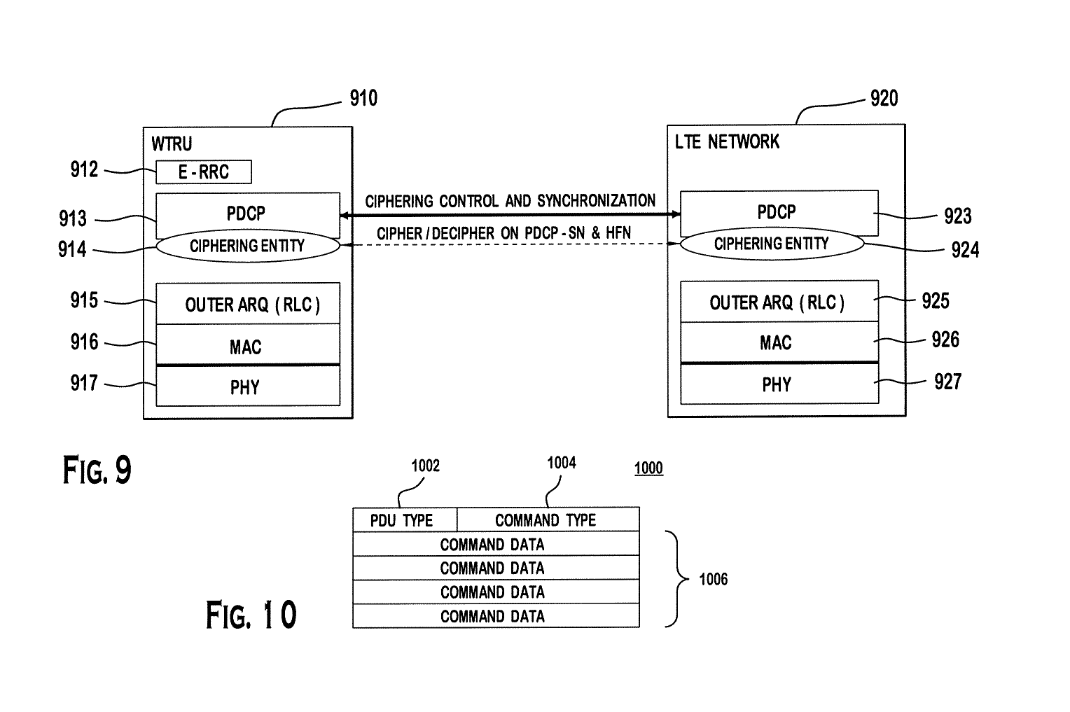

FIG. 8 is a signaling diagram of a process 800 for HFN check in accordance with the present invention. In order to save excessive signaling overhead, the ciphering entities 414, 424 perform an HFN check, (or Count-C check), on a per radio bearer basis in accordance with the present invention.

The LTE network 420 sends an encryption check message to the WTRU 410 to check the HFNs (step 802). The encryption check message includes, for each radio bearer, a radio bearer ID and uplink and downlink HFN values. The WTRU 410 may compare its local HFNs with the HFN values included in the encryption check message (step 804). The WTRU 410 sends an encryption check report message to the LTE network 420 in response to the encryption check message (step 806). If a HFN difference is found for any radio bearer, the WTRU 410 includes its local HFNs of such radio bearer in the encryption check report message. The LTE network 420 may send a synchronization command message to re-synchronize the HFN (step 808). Alternatively, the LTE network 420 may release the radio bearer or do nothing.

Alternatively, after receiving the encryption check message, the WTRU 410 may simply include its local HFNs in the encryption check report message and the LTE network 420 may determine the discrepancy. If any discrepancy is found, the LTE network 420 may re-synchronize the HFNs using the synchronization command message. Alternatively, the LTE network 420 may release the radio bearer or do nothing.

The WTRU 410 may report its HFNs to the LTE network 420 with the encryption check report message whenever it is necessary (step 801). The LTE network 420 may release the radio bearer if the error is unrecoverable, may send a synchronization command message to re-synchronize the HFNs, or may do nothing.

FIG. 9 shows security operations between a WTRU 910 and an LTE network 920 in accordance with another embodiment of the present invention. A WTRU 910 includes an RRC entity 912, a PDCP entity 913, a ciphering entity 914, an RLC entity 915, a MAC entity 916, and a PHY entity 917. The ciphering entity 914 communicates with the PDCP entity 913 for U-plane data. The ciphering entity 914 performs ciphering for the U-plane data. The ciphered data is transmitted via the MAC entity 916 and the PHY entity 917.

The LTE network 920 includes a PDCP entity 923, a ciphering entity 924, an RLC entity 925, a MAC entity 926 and a PHY entity 927. The RLC entity 925 performs ARQ operation with the RLC entity 915. The ciphering entity 924 communicates with the PDCP entity 923 for U-plane data and performs ciphering on the U-plane data.

In accordance with another embodiment of the present invention, the PDCP entities 913, 923 perform ciphering control and ciphering parameter synchronization. The PDCP entities 913, 923 may invoke the ciphering and has an access to the ciphering parameters, such as HFNs. An in-band control signaling, (e.g., a peer to peer PDPC control signaling packet flowing over the U-plane radio bearer or logical channel with the data packets), may help the LTE system managing the ciphering on the U-plane, thereby benefiting all modes of RLC operations.

On the U-plane, the ciphering entity 914, 924 uses a PDCP SN for ciphering. The PDCP entity 913, 923 always has a PDCP SN. The PDCP SN is used to encrypt the PDCP payload and to derive encryption parameters, such as an HFN. The PDCP SN, (14 bits), is long enough to prevent the SN wrap-around from happening too soon, which results in HFN derivation ambiguity. The PDCP 913, 923 is responsible for the maintenance of the HFN values and invoking the ciphering through the PDCP signaling primitives and procedures.

FIG. 10 shows a PDCP control packet 1000 in accordance with the present invention. The PDCP control packet 1000 includes a PDU type field 1002, a command type field 1004 and command data 1006. A new PDU type, (PDCP command PDU), is defined as shown in Table 1 for the PDCP command and control. The PDCP command PDU is used for HFN synchronization, HFN check and report, and SN window range synchronization, which is indicated by the command type field 1004. Table 2 shows exemplary command type field values.

TABLE 1

| Bit | PDU Type |
|---|---|
| 000 | PDCP Data PDU |
| 001 | PDCP SeqNum PDU |
| 010 | PDCP Command PDU |
| 011-111 | Reserved (PDUs with this encoding are invalid for this |
| | version of the protocol) |

TABLE 2

| Bit | Command Type |
|---|---|
| 00000 | HFN Synchronization (PDCP-SYNC) |
| 00001 | HFN Check (PDCP-CHECK) |
| 00010 | HFN Report (PDCP-CHECK-RPT) |
| 00011 | PDCP-SN window Range Synchronization |
| | (PDCP-SN-SYNC) |
| 00100-11111 | Reserved (PDUs with this command type encoding are |
| | invalid for this version of the protocol) |

The control PDCP packets may be ciphered to prevent a security leak. The PDU type field 1002 and the command type field 1004 are not encrypted. A PDCP SN, (if included), is not ciphered, either. The command data may be encrypted using a cipher key (CK), or the WTRU's IMSI (for the COUNT-C) and other fixed values. Should the command dictate the change of HFN or PDCP SN, using the IMSI makes the transition easier.

In accordance with the present invention, a new encryption synchronization procedure and peer messages between the LTE network PDCP and the WTRU PDCP are added to the PDCP protocol as a control signaling message for commanding of the HFN synchronization.

For HFN synchronization, the LTE network 920 sends a synchronization command message to the WTRU 910 to request the WTRU 910 to synchronize its HFNs to the HFN values included in the synchronization command message. The synchronization command message is a PDCP control message and includes HFN synchronization related information for each radio bearer, each of which includes a radio bearer ID, an uplink HFN to be used, a new uplink HFN activation time, (i.e., an SN), a downlink HFN to be used, and a new downlink activation time, (i.e., an SN).

The transmission of the synchronization command message is triggered either by the network, (e.g., the RRC decision for handover or cell change), or by an error report from lower layers. The WTRU 910 then resets its local HFNs with the HFNs included in the synchronization command message. Since the ciphering entity 914 is located above the RLC entity 915, the synchronization command message may take care of all RLC AM, UM and transparent mode (TM) operations in terms of ciphering.

Alternatively, the WTRU 910 may initiate the HFN synchronization procedure by sending a synchronization message including its local HFNs to the LTE network 920 if HFN out-of-sync is detected or whenever it is necessary. The LTE network 920 may send a synchronization command message in response to the synchronization message from the WTRU 910 to synchronize the HFNs.

For SN synchronization, the WTRU 910 and the LTE network 920 send an SN window information per radio bearer to each other. The WTRU 910 sends the SN window information for synchronization in the uplink, and the LTE network 920 sends the SN window information for synchronization in the downlink. The SN window information includes a start SN and a window size. Knowing the SN range helps eliminate the SN overrun and ambiguity and helps the receiver correctly derive the HFNs based on the received SNs. The SN window information may be sent when a transmitting entity is about to send a packet with an SN beyond the current SN window, when a handover or cell change occurs, or when the channel condition is poor and a packet error rate rapidly increases.

In order to save excessive signaling overhead, the PDCP entities 913, 923 perform a Count-C/HFN check on a per radio bearer basis to check the healthiness of the ciphering environment in accordance with another embodiment of the present invention.

The LTE network 920 sends a PDCP check message to the WTRU 910 to check the Count-Cs/HFNs. The PDCP check message includes, for each radio bearer, a radio bearer ID and uplink and downlink Count-C or HFN values. The WTRU 910 may compare its local Count-C or HFN values with the Count-C or HFN values included in the PDCP check message. The WTRU 910 sends a PDCP check report message to the LTE network 920 in response to the PDCP check message. If a Count-C or HFN difference is found for any radio bearer, the WTRU 910 includes its local Count-C or HFN values of such radio bearer in the PDCP check report message. The LTE network 920 may send a synchronization command message to re-synchronize the Count-C or HFN. Alternatively, the LTE network 920 may release the radio bearer or do nothing.

Alternatively, after receiving the PDCP check message, the WTRU 910 may simply include its local Count-C or HFN values in the PDCP check report message and the LTE network 920 may determine the discrepancy. If any discrepancy is found, the LTE network 920 may re-synchronize the Count-Cs or HFNs using the synchronization command message. Alternatively, the LTE network 920 may release the radio bearer or do nothing.

The WTRU 910 may report its Count-C or HFN values to the LTE network 920 with the PDCP check report message whenever it is necessary. The LTE network 920 may release the radio bearer if the error is unrecoverable, may send a synchronization command message to re-synchronize the Count-Cs or HFNs, or may do nothing.

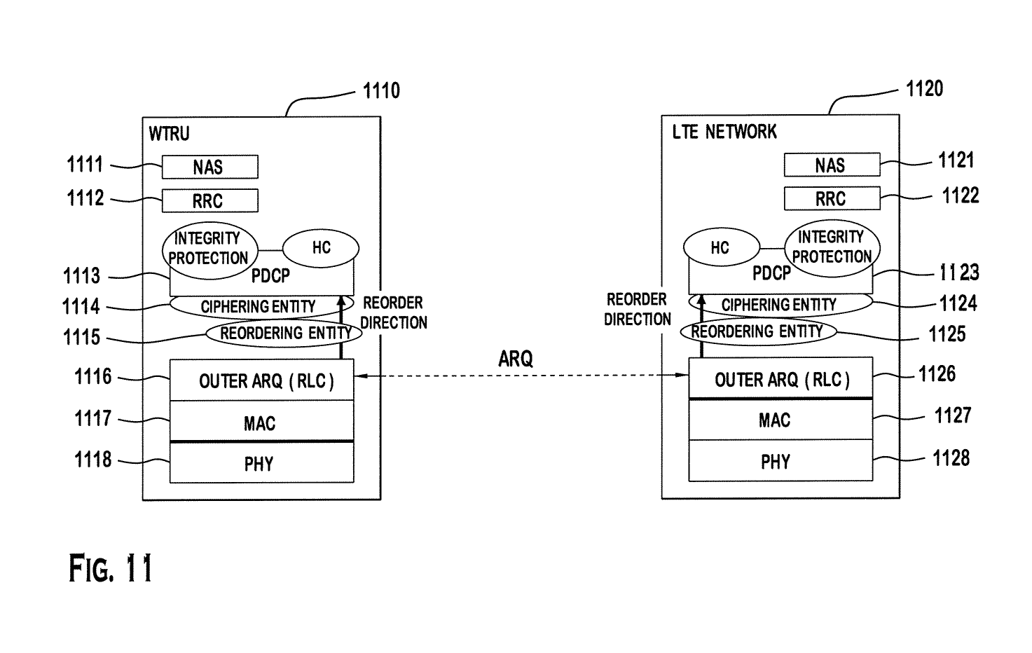

FIG. 11 shows packet reordering operations in a WTRU 1110 and an LTE network 1120 in accordance with the present invention. The WTRU 1110 includes a NAS entity 1111, a RRC entity 1112, a PDCP entity 1113, a ciphering entity 1114, a packet reordering entity 1115, a RLC entity 1116, a MAC entity 1117, and a PHY entity 1118. The LTE network 1100 includes a NAS entity 1121, a RRC entity 1122, a PDCP entity 1123, a ciphering entity 1124, a packet reordering entity 1125, a RLC entity 1126, a MAC entity 1127, and a PHY entity 1128. The packet reordering entities 1115, 1125 are responsible for ensuring in-sequence ordering of received PDCP packets based on the PDCP SN before deciphering and header decompression are performed. The packet reordering is necessary in the case of inter-eNode-B handover. If the PDCP SN is used to derive the HFN, re-ordering would help remove ambiguity for deriving HFN at the turn of SN wrap-around.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless communication system for ciphering control and ciphering parameter synchronization, the system comprising:
a wireless transmit/receive unit (WTRU) including a first ciphering entity configured to perform ciphering and deciphering; and
a network including a second ciphering entity configured to perform ciphering and deciphering, wherein the first ciphering entity and the second ciphering entity perform ciphering control and ciphering parameter synchronization.

2. The system of claim 1 wherein the first and second ciphering entities use a packet data convergence protocol (PDCP) layer sequence number (PDCP SN) for ciphering user plane (U-plane) data.

3. The system of claim 2 wherein the PDCP SN is used to encrypt a PDCP payload.

4. The system of claim 2 wherein the PDCP SN is used to derive a hyper frame number (HFN).

5. The system of claim 1 wherein the first and second ciphering entities use at least one of a non-access stratum (NAS) sequence number (SN), a radio resource control (RRC) SN, and a PDCP SN for ciphering a control plane (C-plane) message.

6. The system of claim 1 wherein the first and second ciphering entities use an encryption sequence number generated by the first and second ciphering entities for ciphering a control plane (C-plane) message.

7. The system of claim 1 wherein a packet generated by the first and second ciphering entities includes a header, the header including a C/D field indicating that the packet is a control packet or a data packet.

8. The system of claim 1 wherein a packet generated by the first and second ciphering entities includes a header, the header including a sequence number length field indicating the length of a sequence number wherein a plurality of different sequence numbers are used.

9. The system of claim 1 wherein the second ciphering entity sends a synchronization command message including a hyper frame number (HFN) to the first ciphering entity wherein the first ciphering entity synchronizes its HFN to the HFN included in the synchronization command message.

10. The system of claim 9 wherein the synchronization command message includes at least one of radio bearer identity (ID), an uplink HFN to be used, an uplink HFN activation time, a downlink HFN to be used, and a downlink HFN activation time.

11. The system of claim 10 wherein the second ciphering entity sends a hash value of the uplink HFN and the downlink HFN to the first ciphering entity.

12. The system of claim 9 wherein transmission of the synchronization command message is triggered by the network.

13. The system of claim 9 wherein transmission of the synchronization command message is triggered by an error report from lower layers.

14. The system of claim 1 wherein the first ciphering entity sends a synchronization message including a hyper frame number (HFN) of the WTRU to the second ciphering entity wherein the second ciphering entity compares the received HFN with an HFN of the network and sends a synchronization command message to the first ciphering entity to synchronize HFNs.

15. The system of claim 1 wherein the WTRU sends sequence number (SN) window information to the network for SN synchronization in uplink, and the network sends SN window information to the WTRU for SN synchronization in downlink.

16. The system of claim 15 wherein the SN window information is sent when a packet with an SN beyond a current window is about to be sent.

17. The system of claim 15 wherein the SN window information is sent when a handover occurs.

18. The system of claim 15 wherein the SN window information is sent when channel quality is poor and a packet error rate increases rapidly.

19. The system of claim 1 wherein the first and second ciphering entities perform hyper frame number (HFN) checking on a per radio bearer basis.

20. The system of claim 19 wherein the second ciphering entity sends an encryption check message to the first ciphering entity, the encryption check message including an uplink HFN and a downlink HFN so that the first ciphering entity checks the received uplink HFN and the downlink HFN with its HFNs.

21. The system of claim 20 wherein the first ciphering entity sends an encryption check response message to the second ciphering entity, the encryption check response message including HFNs stored in the WTRU.

22. The system of claim 1 wherein information for the ciphering control and ciphering parameter synchronization is conveyed by an in-band signaling.

23. The system of claim 1 wherein a payload of a control plane (C-plane) message is encrypted by using a pre-agreed value.

24. The system of claim 23 wherein the pre-agreed value is a WTRU identity.

25. The system of claim 24 wherein the WTRU identity is one of a radio network temporary identifier (RNTI), a packet temporary mobile subscriber identity (P-TMSI) and an international mobile subscriber identity (IMSI).

26. A wireless communication system for ciphering control and ciphering parameter synchronization, the system comprising:
a wireless transmit/receive unit (WTRU) including:
a first ciphering entity for performing ciphering and deciphering; and
a first packet data convergence protocol (PDCP) entity for processing user plane (U-plane) data; and
a network comprising:
a second ciphering entity configured to perform ciphering and deciphering; and
a second PDCP entity for processing the U-plane data,
wherein the first PDCP entity and the second PDCP entity perform ciphering control and ciphering parameter synchronization.

27. The system of claim 26 wherein the first and second ciphering entities use a packet data convergence protocol (PDCP) sequence number (PDCP SN) for ciphering user plane (U-plane) data.

28. The system of claim 27 wherein the PDCP SN is used to encrypt a PDCP payload.

29. The system of claim 27 wherein the PDCP SN is used to derive a hyper frame number (HFN).

30. The system of claim 26 wherein the first and second PDCP entities generate a PDCP control packet including a protocol data unit (PDU) type field that is set to a PDCP command PDU, a command type field and command data.

31. The system of claim 30 wherein the command type field indicates at least one of hyper frame number (HFN) synchronization, HFN checking, HFN reporting and sequence number window synchronization.

32. The system of claim 30 wherein the command data is ciphered.

33. The system of claim 32 wherein the command data is ciphered by using at least one of a cipher key (CK), an international mobile subscriber identity (IMSI) and any fixed value.

34. The system of claim 26 wherein the second PDCP entity sends a synchronization command message including a hyper frame number (HFN) to the first PDCP entity wherein the first PDCP entity synchronizes its HFN to the HFN included in the synchronization command message.

35. The system of claim 34 wherein the synchronization command message includes at least one of radio bearer identity (ID), an uplink HFN to be used, an uplink HFN activation time, a downlink HFN to be used, and a downlink HFN activation time.

36. The system of claim 35 wherein the second ciphering entity sends a hash value of the uplink HFN and the downlink HFN to the first ciphering entity.

37. The system of claim 26 wherein the first PDCP entity sends an synchronization message including a hyper frame number (HFN) of the WTRU to the second PDCP entity wherein the first PDCP entity compares the received HFN with an HFN of the network and sends a synchronization command message to the first PDCP entity to synchronize HFNs.

38. The system of claim 26 wherein the WTRU sends sequence number (SN) window information to the network for SN synchronization in uplink, and the network sends SN window information to the WTRU for SN synchronization in downlink.

39. The system of claim 38 wherein the SN window information is sent when a packet with an SN beyond a current window is about to be sent.

40. The system of claim 38 wherein the SN window information is sent when a handover occurs.

41. The system of claim 38 wherein the SN window information is sent when channel quality is poor and a packet error rate increases rapidly.

42. The system of claim 26 wherein the first and second PDCP entities perform hyper frame number (HFN) checking on a per radio bearer basis.

43. The system of claim 42 wherein the second PDCP entity sends a PDCP check message to the first PDCP entity, the PDCP check message including an HFN of the network so that the first PDCP entity checks the HFN of the network with an HFN of the WTRU.

44. The system of claim 42 wherein the first PDCP entity sends a PDCP check response message to the second PDCP entity, the PDCP check response message including an HFN in the WTRU for each radio bearer.

45. The system of claim 44 wherein the first PDCP entity sends the PDCP check response message in response to a PDCP check message from the second PDCP entity.

46. The system of claim 26 wherein the network includes a reordering entity for reordering PDCP packets based on PDCP sequence numbers before the PDCP packets are deciphered by the second ciphering entity, and the WTRU includes a reordering entity for reordering PDCP packets based on PDCP sequence numbers before the PDCP packets are deciphered by the first ciphering entity.

47. An apparatus for ciphering control and ciphering parameter synchronization, the apparatus comprising:
a packet data convergence protocol (PDCP) entity for processing user plane (U-plane) data;
a non-access stratum (NAS) entity for processing a control plane (C-plane) message; and
a ciphering entity configured to cipher the U-plane data and the C-plane message and perform ciphering control and ciphering parameter synchronization.

48. The apparatus of claim 47 wherein the ciphering entity uses a PDCP sequence number (PDCP SN) for ciphering the U-plane data.

49. The apparatus of claim 48 wherein the PDCP SN is used to encrypt a PDCP payload.

50. The apparatus of claim 48 wherein the PDCP SN is used to derive a hyper frame number (HFN).

51. The apparatus of claim 47 wherein the ciphering entity uses at least one of a NAS sequence number (SN), a radio resource control (RRC) SN, and a PDCP SN for ciphering the C-plane message.

52. The apparatus of claim 47 wherein the ciphering entity uses an encryption sequence number generated by the ciphering entity for ciphering the C-plane message.

53. The apparatus of claim 47 wherein a packet generated by the ciphering entity includes a header, the header including a C/D field indicating that the packet is a control packet or a data packet.

54. The apparatus of claim 47 wherein a packet generated by the ciphering entity includes a header, the header including a sequence number length field indicating a length of a sequence number wherein a plurality of different sequence numbers are used.

55. The apparatus of claim 47 wherein the ciphering entity synchronizes a hyper frame number (HFN) to an HFN received via a synchronization command message from a communication peer.

56. The apparatus of claim 55 wherein the synchronization command message includes at least one of radio bearer identity (ID), an uplink HFN to be used, an uplink HFN activation time, a downlink HFN to be used, and a downlink HFN activation time.

57. The apparatus of claim 47 wherein the ciphering entity is configured to send a synchronization message including its own hyper frame number (HFN) to a communication peer for HFN synchronization.

58. The apparatus of claim 47 wherein the ciphering entity is configured to send sequence number (SN) window information to a communication peer for SN synchronization in uplink, and synchronizes a SN in downlink based on SN window information received from the communication peer.

59. The apparatus of claim 58 wherein the ciphering entity sends the SN window information when a packet with an SN beyond a current window is about to be sent.

60. The apparatus of claim 58 wherein the ciphering entity sends the SN window information when a handover occurs.

61. The apparatus of claim 58 wherein the ciphering entity sends the SN window information when channel quality is poor and a packet error rate increases rapidly.

62. The apparatus of claim 47 wherein the ciphering entity is configured to perform hyper frame number (HFN) checking on a per radio bearer basis.

63. The apparatus of claim 62 wherein the ciphering entity performs the HFN checking based on an encryption check message including an uplink HFN and a downlink HFN received from a communication peer.

64. The apparatus of claim 62 wherein the ciphering entity is configured to send an encryption check response message to a communication peer, the encryption check response message including its own HFNs.

65. The apparatus of claim 47 wherein the ciphering entity encrypts a payload of the C-plane message using a pre-agreed value.

66. The apparatus of claim 65 wherein the pre-agree value is one of a radio network temporary identifier (RNTI), a packet temporary mobile subscriber identity (P-TMSI) and an international mobile subscriber identity (IMSI).

67. An apparatus for ciphering control and ciphering parameter synchronization, the apparatus comprising:
a packet data convergence protocol (PDCP) entity for processing user plane (U-plane) data and performing ciphering control and ciphering parameter synchronization; and
a ciphering entity configured to cipher the U-plane data.

68. The apparatus of claim 67 wherein the ciphering entity uses a PDCP sequence number (PDCP SN) for ciphering the U-plane data.

69. The apparatus of claim 68 wherein the PDCP SN is used to encrypt a PDCP payload.

70. The apparatus of claim 68 wherein the PDCP SN is used to derive a hyper frame number (HFN).

71. The apparatus of claim 67 wherein the PDCP entity generates a PDCP control packet including a protocol data unit (PDU) type field that is set to a PDCP command PDU, a command type field and command data.

72. The apparatus of claim 71 wherein the command type field indicates one of hyper frame number (HFN) synchronization, HFN checking, HFN reporting and sequence number window synchronization.

73. The apparatus of claim 71 wherein the command data is ciphered.

74. The apparatus of claim 73 wherein the command data is ciphered by using one of a cipher key (CK), an international mobile subscriber identity (IMSI) and any fixed value.

75. The apparatus of claim 67 wherein the PDCP entity is configured to perform hyper frame number (HFN) synchronization based on a synchronization command message received from a communication peer.

76. The apparatus of claim 75 wherein the synchronization command message includes at least one of radio bearer identity (ID), an uplink HFN to be used, an uplink HFN activation time, a downlink HFN to be used, and a downlink HFN activation time.

77. The apparatus of claim 67 wherein the PDCP entity sends a synchronization message including its own hyper frame number (HFN) to a communication peer for HFN synchronization.

78. The apparatus of claim 67 wherein the PDCP entity sends sequence number (SN) window information to a communication peer for SN synchronization in uplink, and synchronizes an SN based on SN window information received from the communication peer.

79. The apparatus of claim 78 wherein the SN window information is sent when a packet with an SN beyond a current window is about to be sent.

80. The apparatus of claim 79 wherein the SN window information is sent when a handover occurs.

81. The apparatus of claim 79 wherein the SN window information is sent when channel quality is poor and a packet error rate increases rapidly.

82. The apparatus of claim 67 wherein the PDCP entity performs hyper frame number (HFN) checking on a per radio bearer basis.

83. The apparatus of claim 82 wherein the PDCP entity performs the HFN checking based on a PDCP check message received from a communication peer, the PDCP check message including an HFN of the communication peer.

84. The apparatus of claim 82 wherein the PDCP entity sends a PDCP check response message to a communication peer, the PDCP check response message including its own HFN for each radio bearer.

85. The apparatus of claim 84 wherein the PDCP entity sends the PDCP check response message in response to a PDCP check message from the communication peer.
